(19) United States
(12) Patent Application Publication
(10) Pub. No.: US 2007/0260561 A1
(43) Pub. Date: Nov. 8, 2007

(54) Method and system for processing batches of mail to increase efficiency of the mailstream

(75) Inventors: Murray D. Martin, Ridgefield, CT (US); Joseph E. Wall, Fairfield, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/416,668

(22) Filed: May 3, 2006

(51) Int. Cl. G06F 17/00

(52) U.S. Cl. 705/403

(57) ABSTRACT

A mail processing system and method for reducing delivery expenses is provided. When a mailer prepares a batch of mail pieces, the mailer will print on each mail piece information associated with each mail piece. The mailer provides the batch of mail pieces to a mail processing facility. The mail processing facility can then combine batches of mail received from different mailers together to form a single aggregation. The mail processing facility reads the information associated with each mail piece and sorts the aggregation into a plurality of batches based on the information read from each mail piece. A carrier can then be selected, from among a plurality of different carriers, for each of the plurality of batches that preferably provides the desired delivery services at the lowest cost for delivery.

### FIELD OF THE INVENTION

The invention disclosed herein relates generally to mail processing and delivery systems, and more particularly to a method and system for processing batches of mail to increase the efficiency of the mailstream.

### BACKGROUND OF THE INVENTION

Systems for preparing mail pieces, e.g., generating and printing postage indicia on envelopes and other forms of mail pieces, have long been well known and have enjoyed considerable commercial success. There are many different types of mailing systems, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying onto the mail piece evidence of payment for delivery of that mail piece. The exact configuration of the mailing machine is, of course, particular to the needs of the user. The finished mail pieces would then be provided to a carrier for delivery to the intended recipients.

Many businesses can utilize the mailstream, i.e., the flow of mail, documents and packages among organizations and households, as a driver to grow and reach goals by increasing revenue. Any increases in revenue, however, are offset by the costs for delivery of the mail pieces. As delivery costs continue to increase, mail senders are constantly looking for ways to reduce the expenses associated with delivery of their mail pieces. One such way is for mailers to utilize work sharing programs to take advantage of certain discounts offered by carriers. For example, if the mailers presort their mail pieces, the amount of work required by the carrier to actually deliver the mail pieces is reduced, thereby allowing the carrier to charge lower fees for delivery of those mail pieces. Thus, if a mail sender knows the proper rate that will be charged for the delivery by a selected carrier of a batch of mail pieces that have already been presorted, the mail sender can be prepare the batch of mail accordingly. This can include, for example, applying to each mail piece the appropriate indicium to indicate payment of delivery charges for the selected carrier and appropriate rate before providing the batch of mail to the selected carrier for delivery.

While such work sharing programs generally work well, there are some drawbacks. To qualify for discounts, in many cases the amount of mail being delivered must exceed some threshold. Thus, if a mailer has a batch of mail that does not exceed such a threshold, the discounts will not apply. Many small and medium sized mailers do not have sufficient volumes of mail to qualify for such work sharing discounts, and therefore are unable to enjoy the benefits of lower costs offered by such programs. To overcome such drawbacks, some companies offer presort services to mailers that combines mail pieces from multiple mailers into larger batches that will qualify for such discounts. In some situations, each mailer will process their mail pieces, which may include applying to each mail piece the appropriate indicium to indicate payment of delivery charges for a selected carrier and the appropriate rate without any discounts, and provide the mail pieces to the presort company. The presort company will then combine the batches of mail from different mailers and presort the combined batch to obtain additional discounts. Depending upon the amount of discount that the combined batch will be eligible for, each mailer will then receive a refund of a portion of the difference between the amount originally applied to each mail piece and the amount actually required after applying the determined discount.

While such presort companies enable small to medium sized mailers that would not, on their own, qualify for work sharing discounts to take advantage of such discounts, there are still limitations. For example, in some situations the mailer is still required to account for and print an indicium on each mail piece for a specific carrier utilizing the mailing machines as described above and then receive a refund based on the work sharing discount. Any refunds must then be reconciled with the account from which payment was originally made, which increases the complexity and labor involved. In addition, because the mail pieces as received by the presort companies may already be imprinted with an indicium for a selected carrier or the mailer is required to select a specific single carrier that is supported by the presort company, the presort company can not select different carriers, for a combined batch or any portion thereof, that could provide the same delivery services at a lower rate. Thus, the mailers may not be utilizing the mailstream to the fullest extent possible to reduce costs.

Thus, there exists a need for a method and system for processing batches of mail from different mailers that increases the efficiency of the mailstream by reducing the costs and labor involved for delivery, while still maintaining high service levels, of the batches of mail.

### SUMMARY OF THE INVENTION

The present invention alleviates the problems associated with the prior art and provides methods and systems that reduce the costs and labor involved for delivery of batches of mail while still maintaining high service levels.

In accordance with embodiments of the present invention, the selection of a carrier and accounting for payment to the carrier for delivery of mail can be delayed until after multiple batches of mail from different mailers have been combined to obtain maximum discounts for delivery of the combined batches or portions thereof. When a mailer prepares a batch of mail pieces, the mailer will print on each mail piece information associated with each mail piece. Such information could include, for example, one or more of an identification of the mailer, an identification for the mail piece, a type of service desired for the mail piece, a carrier desired to deliver the mail piece, a geographic destination for each mail piece, a date, an identification of a meter or printer used to generate such information, etc. The information is preferably printed on each mail piece in a machine readable format, such as, for example, a 2D barcode, or in human readable form. The information is preferably located in the region normally reserved for ad slogans, i.e., near the top middle of the face of the mail piece. The mailer preferably does not provide any type evidence of payment for delivery of each mail piece, but instead leaves the area of the mail piece in which this information is typically found (top right) blank.

The mailer provides the batch of mail pieces, prepared as described above, to a mail processing facility. The mail processing facility can then combine batches of mail received from different mailers together to form a single aggregation of mail pieces. The mail processing facility loads the aggregation into sorting equipment equipped with a reading device, such as a scanner or the like. The information provided on each mail piece is read by the reading device, and the aggregate of mail pieces is sorted into a plurality of batches based on the information read from each mail piece. A carrier can then be selected, from among a plurality of different carriers, for each of the plurality of batches that preferably provides the desired services at the lowest cost for delivery. Thus, a different carrier may be utilized to deliver different batches. After selection of a carrier for each of the batches, an indicium for the selected carrier can optionally be printed on each mail piece, or alternatively a manifest that identifies each mail piece can be printed to evidence payment for the mail pieces. By delaying the selection of a carrier and accounting for payment to the carrier for delivery of mail until after multiple batches of mail from different mailers have been combined, the mailers are able to maximize discounts for delivery, without sacrificing desired services, of their mail pieces, thereby increasing the efficiency of the mailstream.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a system for processing mail pieces according to an embodiment of the present invention; and

FIG. 2 illustrates in flow diagram form the operation of the system of FIG. 1 according to an embodiment of the present invention.

### DETAILED DESCRIPTION OF THE PRESENT INVENTION

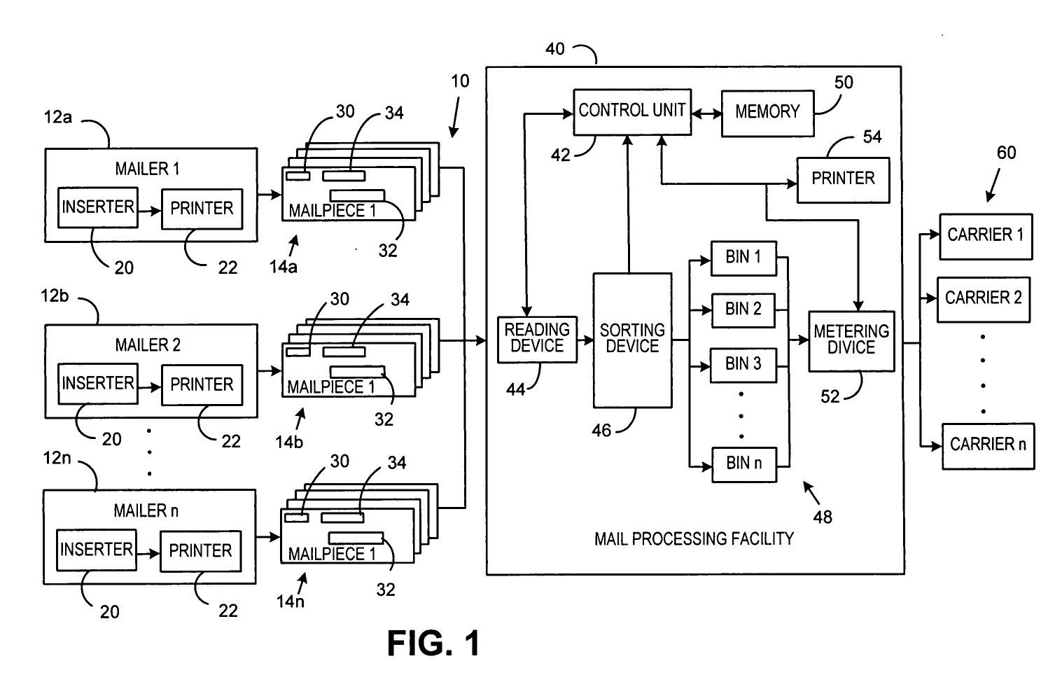

In describing the present invention, reference is made to the drawings, wherein there is seen in FIG. 1 a system 10 for processing mail pieces according to an embodiment of the present invention. System 10 includes a plurality of mailers 12a, 12b, . . . 12n. While only three such mailers 12a, 12b, 12n are illustrated I FIG. 1, it should be understood that any number of different mailers can be included. Each mailer 12a, 12b, 12n could be, for example, a business, corporation or other organization that generates mail pieces for delivery to an intended recipient. The mailers 12a, 12b, 12n can utilize, for example, a personal computer, word processor, or the like (not shown) to generate a mail piece, and also use other mail generation and finishing equipment, such as for example, an inserter 20 and/or a printer 22 to generate mail pieces. Printer 22 could be provided as part of a mailing machine that includes a metering module.

Each mailer 12a, 12b, 12n generates a batch of mail pieces 14a, 14b, 14n, respectively. Any number of individual mail pieces can be included in each batch 14a, 14b, 14n. Each mail piece in each of the batches 14a, 14b, 14n includes some content, e.g., letter, advertisement, brochure, or the like, and an envelope. Each mail piece includes one or more markings printed on the face of the mail piece or on a label applied to each mail piece that includes information associated with each mail piece. Such markings can include, for example, a return address marking 30 and an intended recipient marking 32, e.g., name and address of intended recipient.

According to an embodiment of the present invention, such markings can further include a marking 34 that includes similar or additional information to the markings 30, 32, such as, for example, one or more of an identification of the specific mailer 12a, 12b, 12n, an identification for each mail piece, a type of service desired for the mail piece, a carrier desired to deliver the mail piece, a geographic destination for each mail piece, a date, an identification of a meter or printer used to generate and/or print such marking 34, etc. The marking 34 is preferably printed on each mail piece in a machine readable format, such as, for example, a 2D barcode, or in human readable form. The marking 34 is preferably located in the region normally reserved for ad slogans, i.e., near the top middle of the face of the mail piece as illustrated in FIG. 1, but could be located anywhere on each mail piece. The area normally reserved for an indicium (top right corner of the mail piece) is preferably left blank by each mailer 12a, 12b, 12n, as according to embodiments of the present invention, the mailers 12a, 12b, 12n are not required to select a carrier for delivery of each mail piece and/or provide any type of indicium on each mail piece that evidences payment for delivery of each mail piece. Optionally, this area could be used to provide some type of indication of payment made by the mailer 12a, 12b, 12n, to the mail processing facility 40 instead of a payment made to a carrier for delivery of a mail piece. Payment to a carrier can then be made by the mail processing facility 40 for each mail piece.

The mail processing facility 40 includes a control unit 42 to control operation of various types of equipment utilized to process mail pieces. Control unit 42 could be, for example, a processing system or the like that executes instructions stored in a memory 50 to perform various functions as described below. Mail processing system 40 includes a reading device 44, such as, for example, a scanner, camera, or the like, that can read information provided on mail pieces. A sorting device 46 is provided that can sort mail pieces into different categories based on some predetermined criteria. The different categories of mail pieces can be stored in different bins 48 that are provided in conjunction with the sorting device 46.

Mail processing facility 40 further preferably includes a metering device 52 that can print indicia or other required information on mail pieces for one or more different carriers, and a printing device 54 that can be used to print manifests or the like for different groups of mail pieces. Mail processing facility 40 contracts with a plurality of different carriers 60 for the delivery of mail pieces. Each of the different carriers 60 could be, for example, a governmental agency, e.g., the United States Postal Service (USPS) or similar postal authority for other countries, or a private or commercial carrier. Each of the different carriers charge the mail processing facility 40 various rates for various types of delivery services to deliver mail pieces to different destinations. Some of the different carriers 60 may offer services that other carriers 60 do not provide. Thus, some of the carriers 60 may provide the mail processing facility 40 with better rates than the other carriers for delivery to the same destination. The different rates for each of the carriers 60 can be stored in memory 50 and updated as necessary by the control unit 42 to ensure that all rates are current.

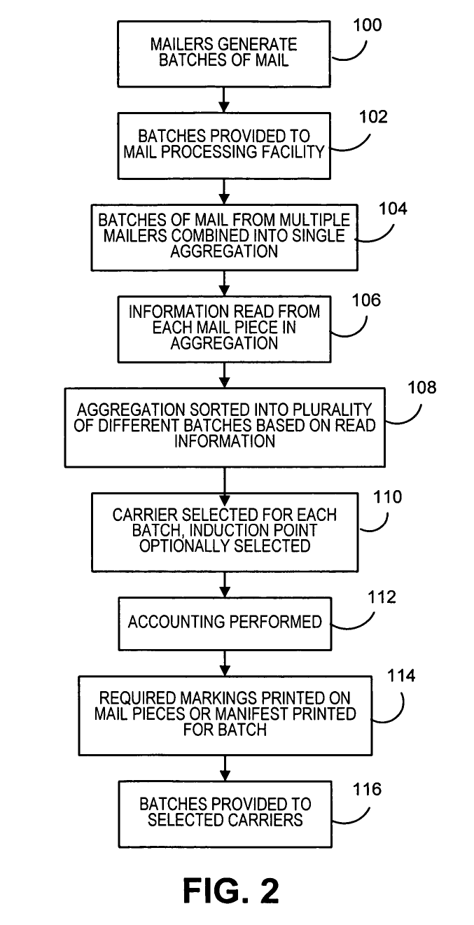

FIG. 2 illustrates in flow diagram form the processing of a mail pieces by the system 10 illustrated in FIG. 1 according to an embodiment of the invention. In step 100, the mailers 12a, 12b, 12n prepare one or more batches of mail pieces, including the marking 34, as described above with respect to FIG. 1. Each of the batches need not meet any required minimal threshold for a number of pieces, delivery area, service type, etc., as the batches will be combined as described below with batches of mail from other mailers. In step 102, the batches from each of the mailers 12a, 12b, 12n are provided to the mail processing facility 40. In step 104, the mail processing facility combines each of the batches from a plurality of different mailers into a single aggregation of mail pieces. The mail processing facility 40 can combine any number of batches from any number of different mailers as desired. In step 106, the markings on each mail piece, including the marking 34 and optionally the markings 30, 32, in the single aggregation are read using the reading device 44.

The information contained in the read markings 30, 32, 34 is provided to the control unit 42. The control unit 42 utilizes the information read from each mail piece to control the sorting device 46, which sorts the single aggregation into a plurality of different batches based on the information read from each mail piece in step 108. For example, the single aggregation can be sorted into different batches based on a desired carrier, geographic destination, desired delivery services or other similar attribute. Geographic destination could include, for example, a specific region, a specific state or country, etc., and can be as large or as small of an area as desired. Delivery services could include, for example, a desired delivery date, e.g., overnight, two day, etc., or a specific value added service, e.g., tracking services, insurance, etc. Each batch may contain one or more mail pieces from each of the different mailers 12a, 12b, 12n from which mail was combined into the single aggregation.

The sorting device 46 preferably diverts each of the mail pieces from the single aggregation into a specified bin 48 such that each bin 48 holds a different batch. The control unit 42 can then determine the best carrier 60 from among the plurality of carriers 60 to deliver each of the different batches of mail in step 110. The selection can be based on the carrier 60 selected by the mailers 12a, 12b, 12n, as provided in the marking 34, or the best available rate that any one of the carriers 60 would charge to deliver a specific batch of mail. For example, the rates that carrier A charges to deliver a batch of mail to a specific destination might be more than the rate carrier B would charge to deliver the same batch, and therefore the control unit will select carrier B for that batch. If a delivery service requested by the mailers is only offered by a single carrier, then that carrier will be the selected carrier for that batch. The control unit 42 will compare the services and rates charged by each of the carriers 60 and select the carrier 60 that can provide the requested services at the best rate.

Optionally, in step 110, selection of a carrier 60 can also include selecting an induction point for a batch of mail. The rates for one or more of the carriers 60 may be dependent upon the location at which the mail is inducted by the carrier 60. For example, a carrier 60 may charge a lower rate for batches of mail to be delivered to the west coast of the U.S. if the batches are inducted at an induction center located near the west coast as opposed to an induction center located near the east coast of the U.S. Thus, if the mail processing facility 40 transports the batch to a different induction center than the one located closest to it for a selected carrier to receive a larger discount, the total costs for the batch, including the cost of transporting the batch to the different induction center, may be less than if the batch was inducted at the induction center located closest to the mail processing facility 40.

Once a carrier for each batch has been selected in step 110, the rate for each mail piece will be known and in step 112 the mail processing facility 40 can perform an accounting for the fee due, including any surcharges added by the mail processing facility 40, for each of the mail pieces in each batch. Such accounting could include, for example, correlating the fee for each mail piece in each of the different batches to the respective mailer 12a, 12b, 12n and debiting a respective account maintained by each mailer 12a, 12b, 12n for the total amount (also known as pre-payment accounting). Accounting could also include, for example, maintaining a record of delivery charges for the mailers 12a, 12b, 12n and generating a respective bill after some predetermined time period, e.g., weekly, bimonthly, etc. to send to each mailer 12a, 12b, 12n (also known as post-payment accounting). Optionally, if a mailer provides a unique identification for each mail piece in the marking 34, the accounting process can associate the specific charge for each mail piece to the identification number, thereby allowing a mailer 12a, 12b, 12n to know the exact fee for each individual mail piece. It should be understood, of course, that any combination of the above accounting functions could be utilized, and not every mailer 1a, 12b, 12n is required to utilize the same type of billing, e.g., pre-payment or post-payment. Additionally, any other types of accounting systems or practices as agreed to by the mail processing facility 40 and mailers 12a, 12b, 12n can be utilized.

Optionally, each of the mail pieces from the batch for that carrier 60 could be further processed in step 114 by metering device 52 and/or printer 54. Processing by the metering device 52 can include, for example, generating an indicium that evidences payment for delivery of each mail piece, and printing the generated indicium on each mail piece or a label for affixing to each mail piece. Processing of each mail piece can also include providing any markings required by the selected carrier 60, using either metering device 52 or printer 54, to indicate the delivery services for each mail piece. Optionally, the control unit 42 can utilize the printer 54 to print a manifest for one or more batches of the mail pieces indicating the amount due for each respective batch. It should be understood, of course, that each different batch of mail may have different processing requirements, based on the selected carrier 60 as well as the desired delivery service.

Once any necessary processing for each of the mail pieces in a batch has been performed, that finished batch can be provided to the selected carrier (or an agent of the carrier), at the proper induction center (if selected) by the mail processing facility 40, along with any required fees, in step 116 for delivery to the intended recipient. By utilizing the present invention, the selection of a carrier and accounting for payment to the carrier for delivery of mail can be delayed until after multiple batches of mail from different mailers have been combined and presorted to obtain maximum discounts for delivery of the combined batches or portions thereof. By delaying the selection of a carrier and accounting for payment to the carrier for delivery of mail until after multiple batches of mail from different mailers have been combined, the mailers are able to maximize discounts for delivery, without sacrificing desired services, of their mail pieces, thereby increasing the efficiency of the mailstream.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method for processing mail pieces comprising:
receiving a first plurality of mail pieces from a first mailer, each mail piece in the first plurality of mail pieces having information associated with each mail piece printed thereon;
receiving a second plurality of mail pieces from a second mailer, each mail piece in the second plurality of mail pieces having information associated with each mail piece printed thereon;
combining the first plurality and second plurality of mail pieces into an aggregation;
reading the information printed on each mail piece in the aggregation;
sorting the aggregation into a plurality of batches of mail pieces based on the information printed on each of the mail pieces;
selecting from a plurality of carriers a respective carrier for delivery of each of the plurality of batches of mail pieces; and
providing each of the plurality of batches of mail pieces to the respective selected carrier for delivery.

2. The method according to claim 1, further comprising:
printing evidence of payment for delivery charges for the respective selected carrier for each of the plurality of batches.

3. The method according to claim 2, wherein printing evidence of payment for delivery charges further comprises:
printing evidence of payment for delivery charges on each mail piece in at least one of the plurality of batches.

4. The method according to claim 2, wherein printing evidence of payment for delivery charges further comprises:
printing evidence of payment for delivery charges on a manifest for at least one of the plurality of batches.

5. The method according to claim 1, wherein the information associated with each mail piece includes a geographic destination of each mail piece.

6. The method according to claim 5, wherein selecting from a plurality or carriers a respective carrier for delivery further comprises:
selecting a respective carrier for delivery based on the geographic destination of each respective batch of mail pieces.

7. The method according to claim 1, wherein the information associated with each mail piece includes a desired carrier service for delivering each mail piece, and sorting the aggregation into a plurality of batches of mail pieces further comprises:
sorting the aggregation into a plurality of batches of mail pieces based on the desired carrier service for delivering each mail piece.

8. The method according to claim 7, wherein the desired carrier service includes a delivery date.

9. The method according to claim 7, wherein the desired carrier service includes tracking services.

10. The method according to claim 7, wherein selecting from a plurality of carriers a respective carrier for delivery further comprises:
selecting a respective carrier for delivery based on the desired carrier services for each respective batch of mail pieces.

11. The method according to claim 1, wherein the selected carrier is identical for at least two of the plurality of batches of mail pieces.

12. The method according to claim 1, wherein the selected carrier is different for at least two of the plurality of batches of mail pieces.

13. The method according to claim 1, wherein the information associated with each mail piece includes a desired carrier for delivering each mail piece, the aggregation is sorted based on the desired carrier, and selecting from a plurality of carriers a respective carrier for delivery further comprises:
selecting the desired carrier for delivery of each of the plurality of batches of mail pieces.

14. The method according to claim 1, further comprising:
accounting for the delivery charges for each mail piece in each of the plurality of batches.

15. The method according to claim 14, wherein the information associated with each mail piece in the first plurality of mail pieces includes an identification of the first mailer, and accounting for the delivery charges further comprises:
identifying an account associated with the first mailer based on the identification of the first mailer; and
debiting the account associated with the first mailer for each mail piece from the first plurality of mail pieces in each batch.

16. The method according to claim 14, wherein the information associated each mail piece in the first plurality of mail pieces includes an identification of the first mailer, and accounting for the delivery charges further comprises:
maintaining a record of the delivery charges for each mail piece from the first plurality of mail pieces; and
utilizing the record, generating a bill to send to the first mailer for the delivery charges for the first plurality of mail pieces.

17. The method according to claim 16, wherein the information associated with each mail piece in the first plurality of mail pieces includes a unique identification of each mail piece, and wherein the record includes the unique identification of each mail piece and delivery charge specifically associated with each mail piece.

18. The method according to claim 1, wherein selecting from a plurality of carriers a respective carrier for delivery of each of the plurality of batches of mail pieces further comprises:
selecting an induction location for at least one of the plurality of batches of mail pieces.
